(19) United States
(12) Patent Application Publication
(10) Pub. No.: US 2008/0198181 A1
(43) Pub. Date: Aug. 21, 2008

(54) VIDEO DISPLAY METHOD AND APPARATUS

(75) Inventors: Yuji KONDO, Kanagawa (JP); Nobuaki HONBO, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD., Kanagawa (JP)

(21) Appl. No.: 12/033,674

(22) Filed: Feb. 19, 2008

(30) Foreign Application Priority Data
Feb. 21, 2007 (JP) 2007-041123

(51) Int. Cl. G09G 5/10

(52) U.S. Cl. 345/690

(57) ABSTRACT

A video display method can lower visibility of flicker in video display and maintain constant display luminance, wherein a display period and a non-display period for a video signal being displayed are provided in one frame period. The method includes frame period controlling by varying the frame period in terms of a single frame or multiple frames as a unit, and display period controlling by varying only the display period or both the display period and the non-display period in the above one frame period depending on variations in the frame period (FIG. 1).

### REFERENCE TO RELATED APPLICATION

This application is based upon and claims the benefit of the priority of Japanese patent application No. 2007-041123, filed on Feb. 21, 2007, the disclosure of which is incorporated herein in its entirety by reference thereto.

### FIELD OF THE INVENTION

This invention relates to methods and apparatus for video display and, more particularly, to methods and apparatus for video display for a liquid crystal display panel.

### BACKGROUND OF THE INVENTION

Recently, efforts in developing a thin type flat panel display (FPD), based on liquid crystal display, are being made briskly. With coming into popular use of the liquid crystal display, the FPD has been used as a monitor for a PC (Personal Computer) in order to display a still image thereon. In these days, with increase in the response speed of the liquid crystal, the FDP is also used for displaying a moving picture, as in TV. However, TFT (Thin Film Transistor) display, representative of the liquid crystal display, is so-called hold type display in which an image is to be held and displayed, so that it suffers from marked display blur or motion blur, in case of displaying a moving picture, in comparison with an impulse type display, typified by a Braun tube (Cathode Ray Tube, CRT), on which image data are displayed only instantaneously but still may be seen as image based on the after-image on the retina of a human.

To remedy this drawback, attempts have so far been made in the TFT liquid crystal display by means of pseudo impulse driving techniques, exemplified by a backlight blinking technique of intermittently lighting or turning on the backlight, a backlight scan technique of splitting the backlight into plural sections and sequentially lighting or turning on the backlight sections, and a black inserting technique of introducing black data into display data. These techniques render it possible to decrease motion blur, thereby improving moving picture characteristics

FIG. 3 depicts an illustrative timing chart in a conventional liquid crystal display apparatus. The timing chart of FIG. 3 is for a case where the backlight scan technique, as one of the pseudo impulse driving techniques, is used. The backlight is turned on after lapse of a preset time, which depends on a response period of a liquid crystal element, as from the time data has been written on the liquid crystal display panel.

### [Patent Document 1]

JP Patent Kokai Publication No. JP-P2005-122199A (page 41, FIG. 9)

### [Patent Document 2]

JP Patent Kokai Publication No. JP-P2005-122200A (page 41, FIG. 9)

### [Patent Document 3]

JP Patent Kokai Publication No. JP-P2005-122201A (page 41, FIG. 9)

### [Patent Document 4]

JP Patent Kokai Publication No. JP-P2006-189658A

### SUMMARY OF THE DISCLOSURE

The following analyses are given by the present invention.

The entire disclosure of Patent Documents 1 to 4 is incorporated herein by reference thereto.

In a technique of turning the backlight on or off, among the techniques of pseudo impulse driving, as shown in FIG. 3, there is raised a problem that flicker (noise) tends to be produced in case of displaying a still image or a moving picture with a slow motion. There is also raised a problem that, if the backlight on ratio, that is, the proportion of the backlight on time in one frame period, is changed, the average display luminance in the frame period is also changed. It should be noticed that flicker is the turn on/off of image which may be perceived in case of representing an image on a display screen, and which may take place only in representing the still image or the moving picture with a slow motion.

In FIG. 9 on page 41 of each of the Patent Documents 1 to 3, all directed to the same contents, there is disclosed a display method, shown herein in FIG. 8. As in the above-mentioned prior-art example, data is written in the liquid crystal display panel during a ‘scanning period’, and the backlight is turned on after lapse of a ‘liquid crystal response period’. Here, the backlight on period is a variable. However, there persists a problem that, since the backlight on time is fixed at a preset user-selected time interval, it is not possible to automatically change the backlight on time period to suppress deterioration of the picture quality ascribable to flicker in the course of the representation.

In the Patent Documents 1-3 and 4, there is disclosed a technique in which the lighting luminance is adjusted depending on the lighting time period to keep the average display luminance in each frame at a constant value. In the following description, the term “display time period” means the backlight on time period during one frame period, while the term “non-display time period” means the remaining time period during the one frame period, that is, a time period other than the backlight on time period. Obviously a frontlight can also be used as a means of lighting.

In case a still image or a moving picture with a slow motion is displayed for video representation of the prior-art example, there results flicker, and hence it is a problem-to-be-solved to prevent the picture quality from deterioration due to flicker.

It is also necessary to keep constant the display luminance, at the same time as the picture quality is to be prevented from deterioration.

According to one aspect of the present invention there is provided a video displaying method, in which a display period and a non-display period for a video signal being displayed are provided in each one of frame periods. The method comprises a frame period controlling step that varies the frame period in terms of a single frame or a plurality of frames as a unit. In the method, a display period controlling step varies only the display period or both the display period and the non-display period in each one frame period depending on variations of the frame period.

According to a second aspect of the present invention there is provided a video displaying apparatus, in which a display period and a non-display period for a video signal being displayed are provided in each one of frame periods. The apparatus comprises frame period controlling means (unit) that varies a frame period in terms of a single frame or a plurality of frames as a unit. In the apparatus, display period controlling means (unit) varies only the display period or both the display period and the non-display period in each one frame period depending on variations in the frame period.

In a first preferred modification of the first aspect of the present invention, the frame periods are cyclically varied in the frame period controlling step.

In a second preferred modification of the first aspect of the present invention, the frame periods are randomly varied in the frame period controlling step.

In a third preferred modification of the first aspect of the present invention, the frame periods are alternately made longer or shorter than an average frame period in the frame period controlling step.

In a fourth preferred modification of the first aspect of the present invention, the video display method further comprises a backlight luminance controlling step that varies backlight luminance by calculations which are based on the display period.

In a first preferred modification of the second aspect of the present invention, the frame periods are cyclically varied by the frame period controlling means (unit).

In a second preferred modification of the second aspect of the present invention, the frame periods are randomly varied by the frame period controlling means (unit).

In a third preferred modification of the second aspect of the present invention, the frame periods are alternately made longer or shorter than an average frame period by the frame period controlling means.

In a fourth preferred modification of the second aspect of the present invention, the video display apparatus further comprises backlight luminance controlling unit (means) that varies backlight luminance by calculations which are based on the display period.

The meritorious effects of the present invention are summarized as follows.

The meritorious effect of the present invention is that, with the video image displaying methods and apparatus, it becomes possible to lower visibility of flicker to improve the picture quality.

With the video image displaying methods and apparatus, according to the present invention, the display luminance for each frame can be kept constant.

### BRIEF DESCRIPTIONS OF THE DRAWINGS

FIG. 1 is a timing chart for a display apparatus according to the present invention.

FIG. 2 is a graph for illustrating a method for backlight luminance adjustment.

FIG. 3 is a timing chart for a conventional display apparatus.

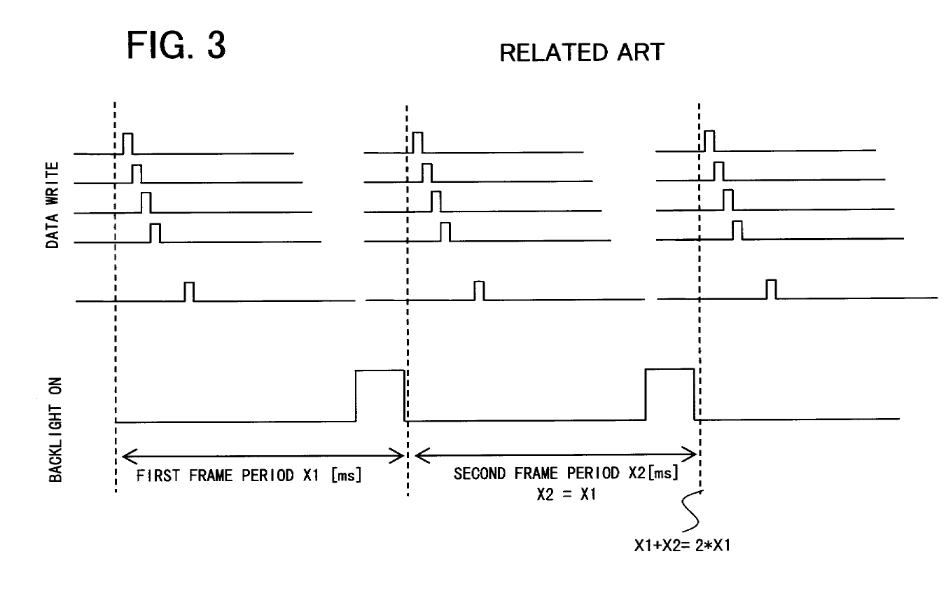

FIG. 4 is a block diagram of a display apparatus of first to third exemplary embodiments of the present invention.

FIG. 5 is a graph for illustrating a method for determining the frame periods according to the first exemplary embodiment of the present invention.

FIG. 6 is a graph for illustrating a method for determining the frame periods according to the second exemplary embodiment of the present invention.

FIG. 7 is a graph for illustrating a method for determining the frame periods according to the third exemplary embodiment of the present invention.

FIGS. 8A, 8B and 8C are diagrams for illustrating the operating principle of a conventional display apparatus.

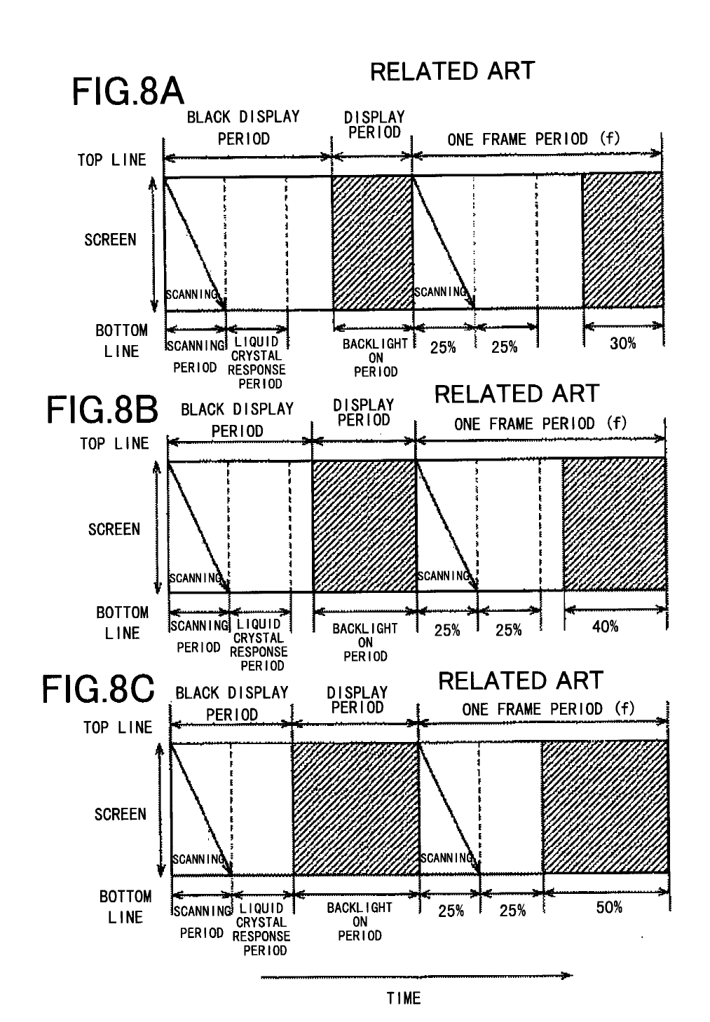

FIG. 9 is a block diagram showing the constitution of a variable period generator used in an exemplary embodiment of the present invention.

### PREFERRED MODES OF THE INVENTION

### First Exemplary Embodiment

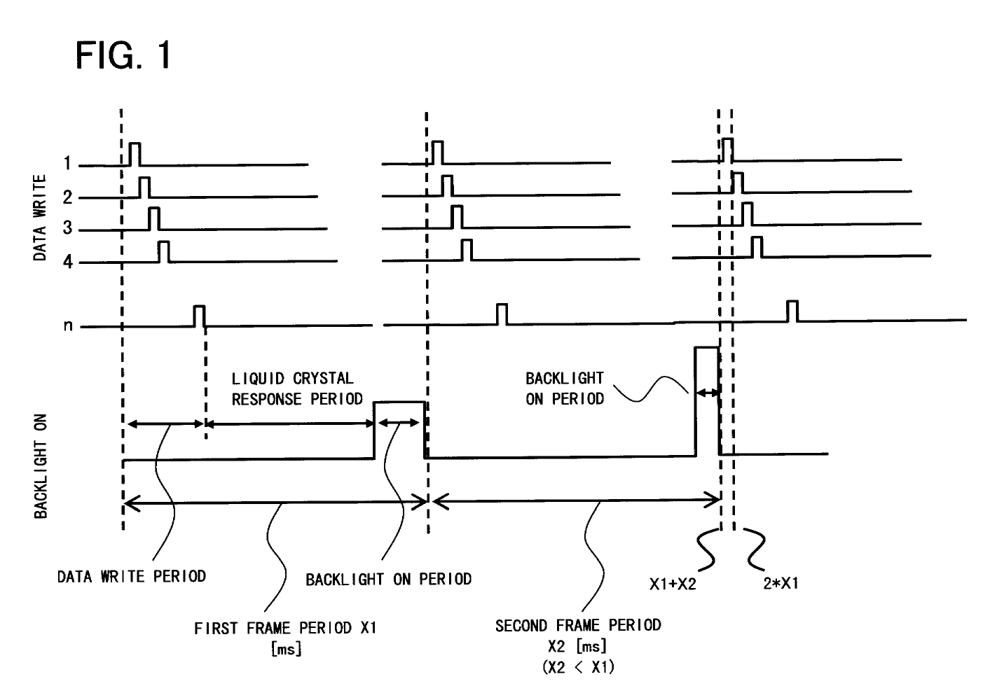

A first exemplary embodiment of the present invention will now be described with reference to FIGS. 1, 4 and 5.

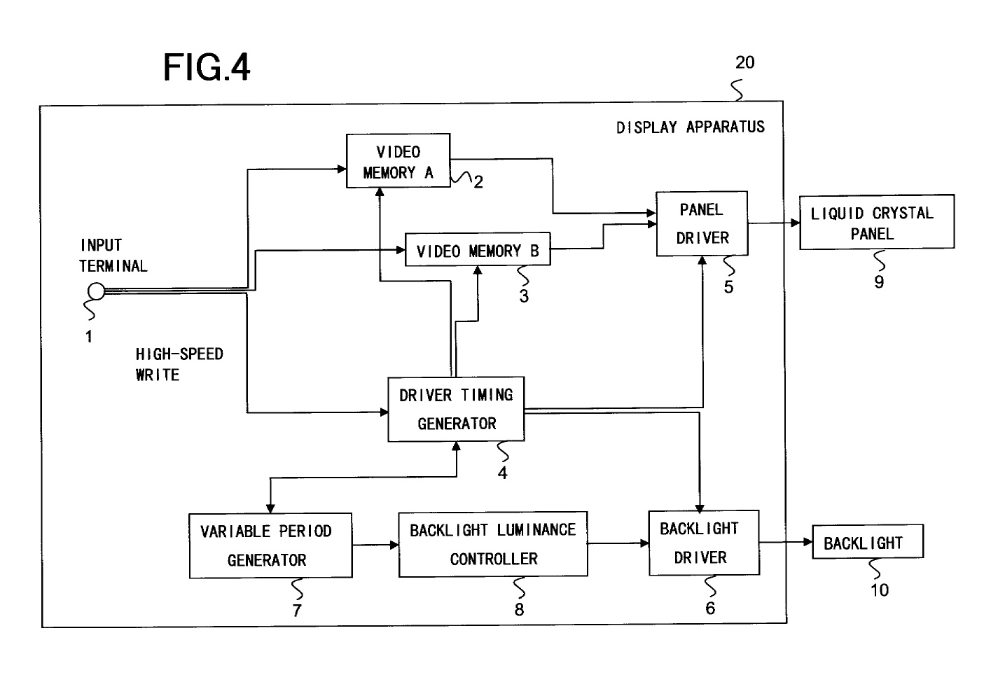

FIG. 4 is a block circuit diagram of a display apparatus of the present first exemplary embodiment. Referring to FIG. 4, the display apparatus 20 includes an input terminal 1, a video memory A2, a video memory B3, a driver timing generator 4, a panel driver 5, a backlight driver 6, a variable period generator 7, and a backlight luminance controller 8. A picture is displayed or not displayed on a liquid crystal display panel (screen) 9 of the display apparatus 20 depending on whether a backlight 10 is turned on (lighted) or turned off (not lighted), respectively. Referring to FIG. 4, the two picture memories, namely the video memory A2 and the video memory B3, provided in the display apparatus 20, are connected to the input terminal 1. The input terminal 1 is also connected to the driver timing generator 4. This driver timing generator is connected to the video memory A2, video memory B3, panel driver 5 and the backlight driver 6 to control their operation. The panel driver 5 is connected to the video memory A2 and to the video memory B3. The driver timing generator 4 is also connected to the variable period generator 7, which is also connected to the backlight luminance controller 8. The backlight luminance controller 8 is connected to the backlight driver 6 to output a luminance signal to the backlight driver 6 to control it. The panel driver 5 and the backlight driver 6 control the liquid crystal display panel 9 and the backlight 10, respectively. The backlight 10 may, for example, be a LED (Light Emitting Diode). It is noted that the number of scanning lines of the liquid crystal display panel 9 is n.

The operation of the display apparatus 20 of the present embodiment will be described with reference to FIG. 1.

Referring to FIG. 1, the time period of a first frame is X1 [ms], while that of a second frame is X2 [ms], where X1>X2.

Data write in the liquid crystal display panel 9 is completed within a ‘data write period’ after the start of the first frame. A timing ‘1’ of data write, indicated in the uppermost row of the timing chart of FIG. 1, denotes the data write timing in the first row of the liquid crystal display panel 9. In a similar manner, the timings ‘2’ to ‘4’ denote the data write timings for the second, third and fourth rows of the liquid crystal display panel 9, respectively. Data write in the ‘n’th row is completed within a time interval equal to about one half of the first frame period, as shown in FIG. 1. This time interval is determined by a response speed of a liquid crystal material actually used. In short, if the response period of the liquid crystal is short, it does not matter if data write takes much time. However, if the response period of the liquid crystal is long, it is necessary that the data write is completed within a shorter time interval. This results because the backlight needs to be turned on after data has been written and the liquid crystal then has transitioned to the state corresponding to the so written data.

After the backlight has been turned on, the second frame period X2 is initiated. After the initiation of the second frame, next data are sequentially written in the liquid crystal display panel 9. The data write speed may be the same as that for the first frame period. Or, the write speed may be adjusted and modified in keeping with the second frame period X2. In the example shown in FIG. 1, the second frame period X2 is shorter than the first frame period X1, so that, if the write periods of the first and second frames are set equal to each other, the backlight on time period in the second frame is shorter than that in the first frame. In this case only the display period is varied in each one frame period depending on variations of the frame period. In addition to this case, both the display period and the non-display period can be varied in each one frame period depending on variations of said frame period. The third frame is initiated after turning off the backlight for the second frame.

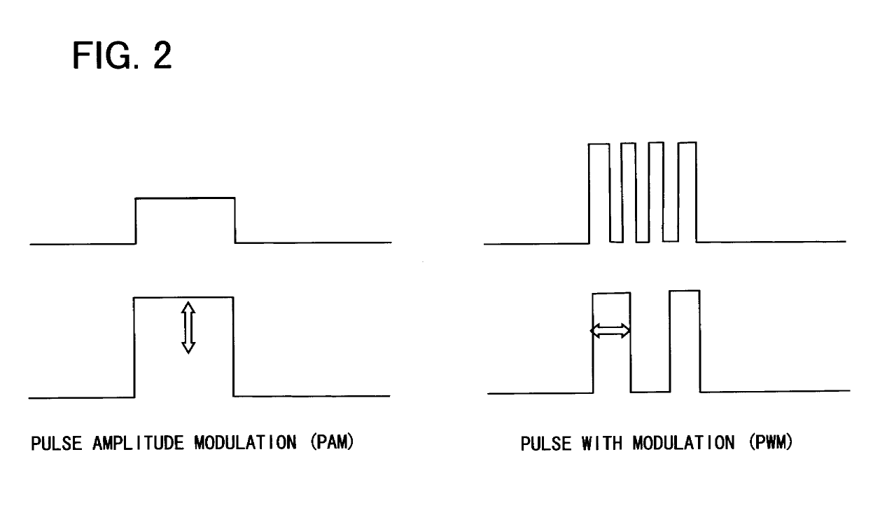

The backlight lighting luminance, that is, the backlight luminance in the on-state, will now be explained with reference to FIG. 1. If, in case the backlight on time period for the second frame is one-half that for the first frame, the average luminance values of the first and second frames are to be kept constant, it is necessary that the luminance of the backlight for the second frame is twice that for the first frame. In case the backlight is to be turned on only for a limited time interval within one frame period, as in the present exemplary embodiment, the luminance of the liquid crystal display panel 9 corresponds to lighting luminance of the backlight averaged over the entire frame period. Thus, if the frame period differs from one frame to the next, but the average luminance values of the respective frames are the same, the luminance of the liquid crystal display panel 9 becomes constant regardless of whether the frame period is long or short per each frame. Examples of the methods for adjusting the backlight luminance include a method for raising the luminance value (Pulse Amplitude Modulation, PAM), and a method for varying the number (frequency) of pulse repetitions, with the luminance value of each pulse remaining the same (Pulse Width Modulation, PWM), as shown in FIG. 2. One of these methods may be selected and used based on the constitution of the light source of the backlight and the performance of the backlight driving circuit.

The circuit block will now be described with reference to FIG. 4.

A video signal and a timing control signal are delivered from the input terminal 1. Of these, the video signal is written in the video memory A2. Since the input signal in general is written at 60 Hz, the case where the video signal is delivered at 60 Hz is taken as an example in the following description of the operation of the circuit block.

For the first frame, data are written at 60 Hz in the video memory A2 in synchronization with the input signal. The input timing control signal is delivered to the driver timing generator 4. The driver timing generator 4 has a function of providing for an internal operating speed (rate) of the present circuit which is higher than a basic clock of the input signal, and also exercises control for alternately writing the input signal in the video memory A2 and in the video memory B3.

For the second frame, the video signal is written in the video memory B3. The video signal, written in the video memory A2 during the first frame period, is output within a time interval sufficiently shorter than one frame period, by a control signal supplied from the driver timing generator 4, and is delivered to the panel driver 5. For example, if one frame period is 16.66 ms, the video signal is output to the panel driver 5 within a time of 5 to 8 ms.

For the third frame, the video signal, delivered from the input terminal 1, is written in the video memory A2, whilst the video signal, written in the video memory B3, is output to the panel driver 5 within a time sufficiently shorter than one frame period.

By the above operation, data may be written in the panel driver 5 with a period different from 60 Hz, even though the input signal is supplied at 60 Hz, for instance.

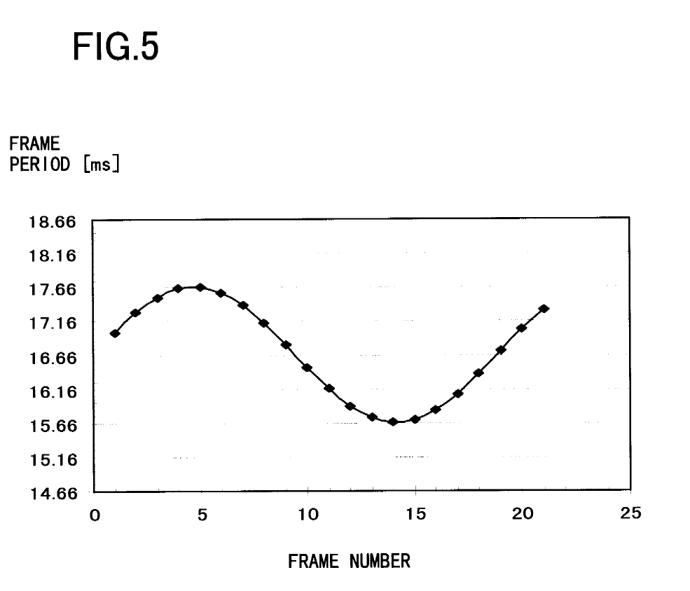

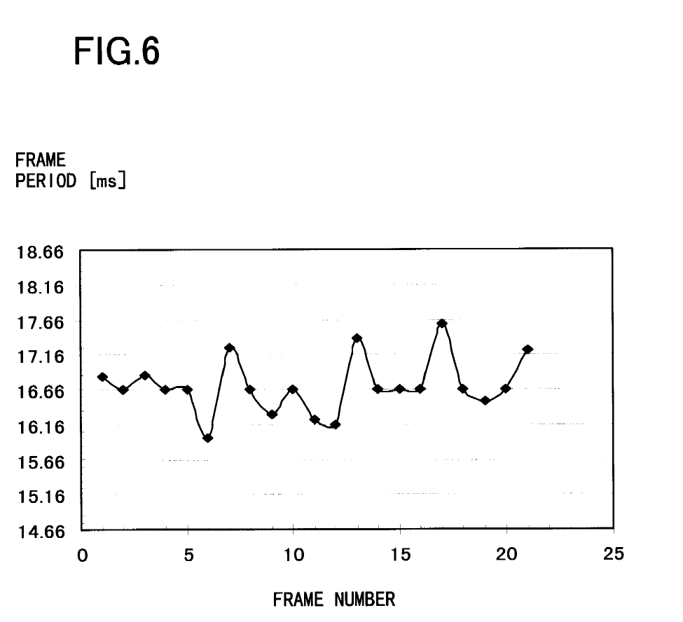

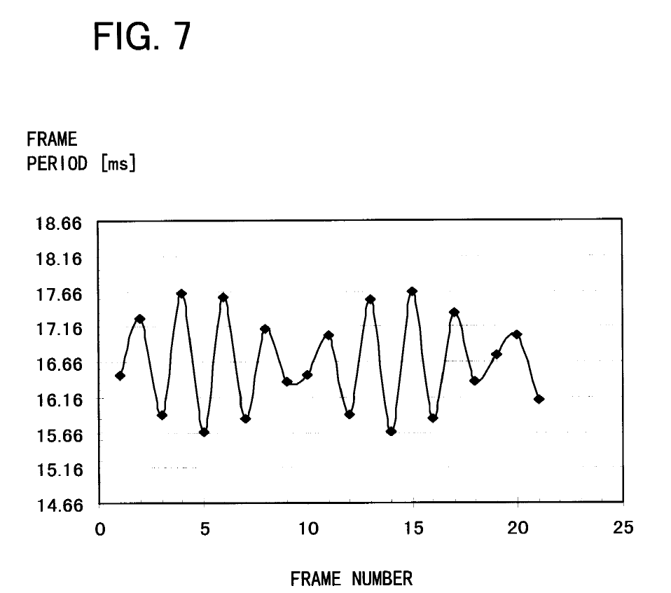

The operation of the variable period generator 7 will now be described. The variable period generator 7 varies the frame period and transmits the so varied frame period to the driver timing generator 4. The variable period generator 7 acts as frame period control means for determining the length of the next frame period. A large variety of frame period determining methods may be employed. FIGS. 5 to 7 show a few exemplary methods for determining the frame period. The frame period can be varied in terms of a single frame or a plurality of frames as a unit. FIG. 5 shows an example where the frame period is varied in terms of a plurality of frames as a unit. Each of FIGS. 6 and 7 shows an example where the frame period is varied in terms of a single frame period.

If once a period of a frame to be displayed next has been set by the variable period generator 7, acting as frame period control means, the backlight luminance controller 8 calculates a luminance of the backlight 10, required for the next frame, based on a standard lighting period, for example, lighting period in case of the operation at 60 Hz and the period of the next frame, determined as described above. Although a variety of computing methods for the backlight luminance required for the next frame may be employed, the simplest method is such a one in which the luminance is inversely proportionate to the lighting period. Specifically, if the lighting period is 1.2 times the standard lighting period, the luminance for the next frame is set to a value equal to the reciprocal of 1.2, that is, 1/1.2=0.83333, times the standard lighting period. As another computing method, the backlight luminance is computed as factors other than the lighting period dependent on the frame frequency are taken into account. For example, the luminance may be varied in keeping with an environment in which the display is placed. The luminance value is sent in this manner from the backlight luminance controller 8 to the backlight driver 6. The backlight driver 6 receives this luminance value, and a lighting start signal, which is transmitted from the driver timing generator 4, to turn on the backlight 10 at a desired timing to the desired luminance value.

The panel driver 5 also receives the timing signal from the driver timing generator 4 and the video signals from the video memories A2 and B3 to display an image on the liquid crystal display panel 9.

FIG. 5 shows an example in which frame periods exhibit periodicity such that the length of the frame period is increased from an average period, which in FIG. 5 is 16.66 ms, equivalent to 60 Hz, then decreased and increased repeatedly. It is seen from FIG. 5 that the frame period is changed continuously about the average period of 16.66 ms as center, within the range of 1 ms on each side (plus and minus). In FIG. 5, the period of this change is approximately 20 frames. It is however not restricted to 20 frames and may be adjustable depending on the size or the resolution of the liquid crystal display panel 9 used.

The state in which a backlight is turned on or off within one frame period is perceived in most cases as flicker. Such flicker occurs (i.e., is perceived) within a certain frequency range that may be recognized by the viewer. In general, when the light turn on/turn off frequency exceeds 48 Hz, the light turn on/turn off state is hardly recognizable as flicker.

However, even a flicker with a frequency of an order of 60 Hz may sometimes be recognized, depending on the size of the liquid crystal display panel 9 or the sort of the video displayed. In particular, flicker exhibiting periodicity may readily be recognized. Thus, with the present example, in which the frame frequency is changed periodically, the light turn on/turn off states are less likely to be recognized as flicker. Consequently, with the present example, it is possible to render flicker less perceptible, thereby improving the picture quality.

### Second Exemplary Embodiment

A second exemplary embodiment of the present invention will now be described with reference to FIGS. 4 and 6. The constitution of the display apparatus of the present exemplary embodiment is shown in FIG. 4.

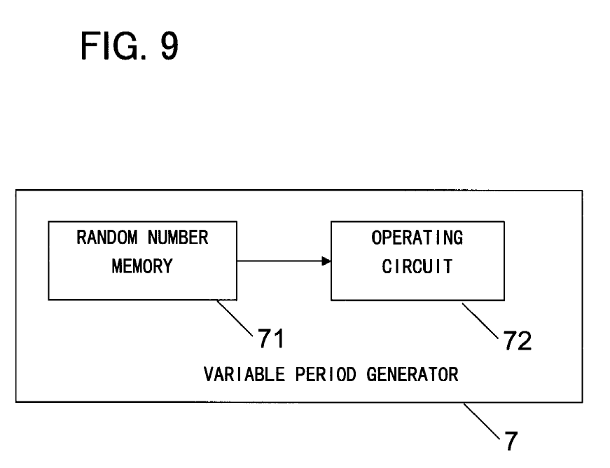

In the first exemplary embodiment, the frame period is changed periodically (FIG. 5). In the present second exemplary embodiment, the frame period is changed randomly, as shown in FIG. 6. In a block diagram of FIG. 9, there is shown the constitution of a variable period generator 7 of the present second embodiment. Referring to FIG. 9, a variable period generator 7 (frame period controlling means) includes a random number memory 71 and an operating circuit 72. The random number memory 71 stores random numbers written therein. The operating circuit 72 reads out the random numbers written in the random number memory 71 and executes preset operations to generate frame periods. For example, if the frame periods are varied at random, about the average frame period, as center, the operating circuit 72 sets the frame period to 16.66+A*(2*r−1), where the random number is denoted as r, r being in a domain of 0˜1, and a suitable amplitude is denoted as A. It should be noticed that, in FIG. 6, the period is randomly varied to larger or smaller amplitudes, about the average frame period (16.66 ms) as center. Since frame period variations in the present second exemplary embodiment are more random in comparison with the first exemplary embodiment, the flicker is less likely to be recognized. The display luminance in the present second exemplary embodiment can be kept constant by varying the luminance of the backlight depending on the backlight on time period for each frame as explained in the first exemplary embodiment.

### Third Exemplary Embodiment

A third exemplary embodiment of the present invention will now be described with reference to FIGS. 4 and 7. The constitution of the display apparatus of the present third exemplary embodiment is shown in FIG. 4.

In the present third exemplary embodiment, the frame-based variations in the frame periods are random. Moreover, the directions of the variations in the frame periods are alternately interchanged from one frame to the next. That is, if a frame period in a given frame is longer than the average frame period, a frame period of the next frame is shorter than the average frame period. FIG. 9 shows, in a block diagram, the constitution of a variable period generator 7 of the present embodiment. An operating circuit 72 reads out the random numbers stored in the random number memory 71 and executes preset operations thereon to generate frame periods. In the present exemplary embodiment, the frame periods are varied at random, with the preset average frame period as center. In addition, in the present embodiment, the frame periods are set so as to be alternately longer and shorter than the average frame period. For example, if the frame period is varied at random, centered about the average frame period, as shown in FIG. 7, the operating circuit 72 sets the frame period to 16.66+A*r*(2*mod(N, 2)−1), where r denotes the random number in a domain of 0˜1, A denotes a suitable amplitude and N denotes the frame number. It should be noticed that, in the present third exemplary embodiment, frame period variations from one frame to the next frame become larger in comparison with the first and second exemplary embodiments, so that flicker is less likely to be recognized. The display luminance in the present third exemplary embodiment can be kept constant by varying the luminance of the backlight depending on the backlight on time period for each frame as explained in the first exemplary embodiment.

### INDUSTRIAL APPLICABILITY

The display driving methods and apparatus may be used for all sorts of the flat panel display. They may be used not only for a liquid crystal display with a backlight but also for a liquid crystal display with a frontlight.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A video display method comprising
providing a display period and a non-display period for a video signal being displayed in each one of frame periods;
controlling a frame period by varying the frame period in terms of a single frame or a plurality of frames as a unit; and
controlling a display period by varying only the display period or both the display period and the non-display period in each one frame period depending on variations of said frame period.

2. The video display method according to claim 1 wherein said frame periods are cyclically varied in said controlling of the frame period.

3. The video display method according to claim 1 wherein said frame periods are randomly varied in said controlling of the frame period.

4. The video display method according to claim 1 wherein said frame periods are alternately made longer or shorter than an average frame period in said controlling of the frame period.

5. The video display method according to claim 1 further comprising:
a backlight luminance controlling step of varying backlight luminance by calculations which are based on said display periods.

6. A video display apparatus comprising:
means for providing a display period and a non-display period for a video signal being displayed in each one of frame periods;
frame period controlling means for varying a frame period in terms of a single frame or a plurality of frames as a unit; and
display period controlling means for varying only a display period or both the display period and a non-display period in each one frame period depending on variations in the frame period.

7. The video display apparatus according to claim 6 wherein said frame period controlling means causes the frame period to be varied cyclically.

8. The video display apparatus according to claim 6 wherein said frame period controlling means causes the frame period to be varied randomly.

9. The video display apparatus according to claim 6 wherein said frame period controlling means causes said frame periods to be alternately longer or shorter than an average frame period.

10. The video display apparatus according to claim 6 further comprising:
backlight luminance controlling means for varying backlight luminance by calculations based on the display period.

11. A video display apparatus in which a display period and a non-display period for a video signal being displayed are provided in each one of frame periods, comprising:
a frame period controlling unit that varies a frame period in terms of a single frame or a plurality of frames as a unit; and
a display period controlling unit that varies only a display period or both the display period and a non-display period in each one frame period depending on variations in the frame period.

12. The video display apparatus according to claim 11 wherein said frame period controlling unit causes the frame period to be varied cyclically.

13. The video display apparatus according to claim 11 wherein said frame period controlling unit causes the frame period to be varied randomly.

14. The video display apparatus according to claim 11 wherein said frame period controlling unit causes said frame periods to be alternately longer or shorter than an average frame period.

15. The video display apparatus according to claim 11 further comprising:
a backlight luminance controlling unit that varies backlight luminance by calculations based on the display period.
